(19) United States
(12) Patent Application Publication
(10) Pub. No.: US 2025/0033888 A1
(43) Pub. Date: Jan. 30, 2025

(54) WIRING MODULARIZED BATTERY TRANSPORT SYSTEM AND METHOD OF CONSTRUCTING THE SAME

(71) Applicant: SK ON CO., LTD., Seoul (KR)

(72) Inventor: Kang Hyuk CHOI, Daejeon (KR)

(21) Appl. No.: 18/774,935

(22) Filed: Jul. 17, 2024

(30) Foreign Application Priority Data
Jul. 27, 2023 (KR) 10-2023-0098182
Jun. 17, 2024 (KR) 10-2024-0078404

(51) Int. Cl. B65G 13/11; B65G 13/02; B65G 21/10

(52) U.S. Cl. CPC B65G 13/11; B65G 13/02; B65G 21/10; B65G 2207/30

(57) ABSTRACT

A wiring modularized battery transport system and a method of constructing the same are provided. The battery transport system includes a first wiring portion including a plurality of transport members configured to transport a transport object in a predetermined direction, a second wiring portion including local panel electrically connected to at least one of the plurality of transport members, a third wiring portion including a wiring panel electrically connected to the local panel and supplying power to the local panel, and a connector respectively provided in the first wiring portion, the second wiring portion, and the third wiring portion, and electrically connecting the first wiring portion, the second wiring portion, and the third wiring portion to each other. The connector connects the first wiring portion, the second wiring portion, and the third wiring portion to each other in a detachable manner.

### CROSS-REFERENCE TO RELATED APPLICATION(S)

This patent document claims the priority and benefits of Korean Patent Application No. 10-2023-0098182 filed on Jul. 27, 2023 and Korean Patent Application No. 10-2024-0078404 filed on Jun. 17, 2024, the disclosures of which are incorporated herein by reference in their entirety.

### TECHNICAL FIELD

The disclosure and implementations disclosed in this patent document generally relate to a wiring modularized battery transport system and a method of constructing the same.

### BACKGROUND

Unlike primary batteries, secondary batteries are convenient in that they may be charged and discharged, and are receiving a lot of attention as a power source for various mobile devices, electric vehicles and the like. Unlike primary batteries, secondary batteries may be charged and discharged, and therefore, may be applied to devices within various fields, such as digital cameras, mobile phones, laptops, hybrid cars, electric cars, and energy storage systems (ESS).

A secondary battery may include a battery cell in which an electrode assembly formed by stacking a positive electrode plate, a negative electrode plate, and a separator, or winding the same in a roll shape, is accommodated inside a case. A plurality of battery cells may be stacked in a predetermined direction and accommodated in a battery module or a battery pack. Such secondary batteries may be manufactured or transported while being transported by a transport member such as a conveyor.

On the other hand, the transport member may be connected to other transport member or auxiliary parts through wiring work. Such wiring work may result in variations in work time and work quality depending on the worker's level of skill, which may affect reliability and safety of electrical connectivity.

Accordingly, it may be important to improve the reliability of overall electrical wiring work by allowing even beginners to easily perform wiring work on the transport member.

### SUMMARY

The present disclosure may be implemented in some embodiments to provide a battery transport system and a method of constructing the same, in which the time required for wiring work on a transport member may be significantly reduced.

The present disclosure may be implemented in some embodiments to provide a battery transport system in which a wiring structure of a transport member may be quickly changed, and a method of constructing the same.

The present disclosure may be implemented in some embodiments to provide a battery transport system and a method of constructing the same, in which reliability and safety of wiring work on a transport member may be improved.

Battery cells transported in a wiring modularization system according to some embodiments may be widely applied in green technology fields such as electric vehicles, battery charging stations, and solar power generation and wind power generation using batteries. Additionally, battery cells may be used in eco-friendly electric vehicles, hybrid vehicles, and the like, to prevent climate change by suppressing air pollution and greenhouse gas emissions.

In some embodiments, according to an embodiment, a battery transport system includes a first wiring portion including a plurality of transport members configured to transport a transport object in a predetermined direction; a second wiring portion including a local panel electrically connected to at least one of the plurality of transport members; a third wiring portion including a wiring panel electrically connected to the local panel and supplying power to the local panel; and a connector respectively provided in the first wiring portion, the second wiring portion, and the third wiring portion, and electrically connecting the first wiring portion, the second wiring portion, and the third wiring portion to each other. The connector connects the first wiring portion, the second wiring portion, and the third wiring portion to each other in a detachable manner.

The connector may be provided on each of the plurality of transport members, and the plurality of transport members may be arranged in the predetermined direction and electrically connected to each other through the connector in a detachable manner.

The plurality of transport members may include a first transport member provided with the connector. The first transport member may include a first frame portion including a first body frame and a first support frame supporting the first body frame; a first roller unit arranged in the predetermined direction on the first body frame and including a first driving roller rotating when supplied with power; a first roller driving unit supplying power to and controlling the first roller unit; and a first terminal portion electrically connecting the first roller driving unit and the connector to each other. The first roller driving unit and the first terminal portion may be disposed inside the first frame portion provided by the first body frame and the first support frame.

The first frame portion of the first transport member may be provided as a plurality of first frame portions arranged in the predetermined direction and coupled to each other by a connection portion, the first driving roller may be respectively disposed on the first body frames of the plurality of first frame portions, and the first roller driving unit may be respectively connected to the first driving roller of the first frame portion and may be disposed on only one of the plurality of first frame portions.

The connector of the first transport member may include an input connector disposed on one side of the plurality of first frame portions and receiving current, and an output connector disposed on the other side and supplying current to a neighboring transport member. The first terminal portion may electrically connect the first roller driving unit, the input connector, and the output connector to each other, and may be disposed on only one of the plurality of first frame portions.

The plurality of transport members may include a second transport member provided with the connector. The second transport member may include a second frame portion including a second body frame and a second support frame supporting the second body frame; a second roller unit arranged in the predetermined direction in the second body frame and including a second driving roller rotating when supplied with power; a second roller driving unit supplying power to and controlling the second driving roller; and a second terminal portion electrically connecting the second roller driving unit and the connector to each other; an accessory member configured to assist in transporting the transport object; and a unit box supplying power to the accessory member. The second roller driving unit, the second terminal portion, and the unit box may be disposed inside the second frame portion provided by the second body frame and the second support frame.

The plurality of transport members may include a third transport member provided with the connector. The third transport member may include a third frame portion disposed with an auxiliary member capable of f transporting the transport object in a direction different from the predetermined direction; and a unit box electrically connecting the auxiliary member and the connector to each other. The unit box may be disposed inside the third frame portion.

The unit box of the third transport member may be electrically connected to either the first terminal portion of the first transport member or the second terminal portion of the second transport member, neighboring to each other.

At least one of the plurality of transport members may be configured to be changeable in a position, based on the predetermined direction, through the connector.

In some embodiments according to an embodiment, a method of constructing a battery transport system includes a preparation operation of preparing a first wiring portion including a plurality of transport members transporting a transport object in a predetermined direction, a second wiring portion including at least one local panel, and a third wiring portion including at least one wiring panel; a wiring modularization operation of providing a connector on the plurality of transport members of the first wiring portion, the second wiring portion, and the third wiring portion; and an installation operation of electrically connecting the first wiring portion, the second wiring portion, and the third wiring portion to each other by the connector.

At least one of the plurality of transport members may include a frame portion including a body frame, a roller unit arranged on the body frame and transporting the transport object, a roller driving unit supplying power to and controlling the roller unit, and a terminal portion electrically connecting the roller driving unit and the connector to each other. The wiring modularization operation may include electrically connecting the roller driving unit and the connector to each other through the terminal portion, and disposing the roller driving unit and the terminal portion inside the frame portion.

In the wiring modularization operation, the connector may be mounted on ends of wires of the plurality of transport members, the local panel, and the wiring panel.

The installation operation may include arranging the plurality of transport members in a transport direction of the transport object, and connecting respective connectors provided on the plurality of transport members to each other in the predetermined direction.

The installation operation may include connecting the connector of at least one of the plurality of transport members and the connector of the local panel to each other, and connecting the connector of the local panel and the connector of the wiring panel to each other.

The method of constructing a battery transport system may further include transporting the first wiring portion, the second wiring portion, and the third wiring portion to a predetermined position, between the wiring modularization operation and the installation operation.

### BRIEF DESCRIPTION OF DRAWINGS

Certain aspects, features, and advantages according to an embodiment are illustrated by the following detailed description with reference to the accompanying drawings.

FIG. 1 is a schematic diagram of an electrical wiring of a battery transport system according to an embodiment.

FIG. 2 is a schematic diagram of a first transport member according to an embodiment.

FIG. 3 is a schematic diagram of a transport member according to an embodiment.

FIG. 4 is a schematic diagram of a second transport member equipped with an accessory member according to an embodiment.

FIG. 5 is a schematic diagram of a third transport member according to an embodiment.

FIG. 6 is a diagram illustrating an electrical wiring system according to an embodiment.

FIG. 7 is a view of A in FIG. 6.

FIG. 8 is a view of B in FIG. 6.

FIG. 9 is a flowchart illustrating a method of constructing a battery transport system according to an embodiment.

### DETAILED DESCRIPTION

Features according to an embodiment disclosed in this patent document are described by example embodiments with reference to the accompanying drawings.

Prior to the detailed description of example embodiments, terms or words used in the descriptions below and claims should not be construed as being limited to their usual or dictionary meanings, and should be interpreted with meanings and concepts consistent with the technical idea according to an embodiment, based on the principle that the inventor may appropriately define the concept of terms to explain his or her invention in the best manner possible.

The same reference numbers or symbols in respective drawings indicate parts or components that perform substantially the same function.

In the following description, singular expressions include plural expressions unless the context clearly dictates otherwise. Terms such as “include,” “configure” and the like are intended to designate the presence of features, steps, numbers, operations, components, parts, or combinations thereof described in the specification, and should be understood as not precluding the presence or addition of one or more other features, numbers, steps, operations, components, parts, or combinations thereof.

In addition, in the following description, expressions such as upper side, upper portion, lower, bottom, side, front, rear, and the like are expressed based on the directions illustrated in the drawing, and it should be noted in advance that if the direction of the object is changed, it may be expressed differently.

Additionally, in the descriptions below and claims, terms including ordinal numbers such as “first,” “second,” and the like may be used to distinguish between components. These ordinal numbers are used to distinguish identical or similar components from each other, and the meaning of the term should not be interpreted limitedly due to the use of these ordinal numbers. For example, components combined with these ordinal numbers should not be interpreted as having a limited order of use or arrangement based on the number. If necessary, respective ordinal numbers may be used interchangeably.

The battery transport system in the present disclosure may be used to transport battery cells to a required location in the manufacturing process of secondary batteries (battery cells). For example, the present disclosure may be used in a cell formation process in the secondary battery manufacturing process. The cell formation process is a process that activates the secondary battery including the electrode assembly while charging/discharging the secondary battery. In the cell formation process, secondary batteries produced through previous manufacturing process operations may be moved by transport members such as conveyors.

The transport member is equipped with an accessory member such as diverters, home stands, and lifters that change the transport position of the secondary battery, which is the transport object, and thus, secondary batteries transported by the transport member are transported in a different direction or moved to a specific area, thereby effectively handling logistics.

On the other hand, the above-described transport member and accessory member may respectively be provided with electrical wiring such as a cable for receiving power. Due to the nature of the transport member being arranged relatively long in the transport direction, wiring work of organizing and connecting the electrical wiring of the transport member and the accessory member may become complicated.

In this case, ‘wiring work’ may be the work of connecting electrical wiring between the transport member and other accessory members or other parts. For such wiring work, the working time may vary depending on a worker's level of skill. In addition, since wiring work should be done for each transport member and accessory member, an absolute amount of time should be spent to electrically connect the cables, and thus, there may be a problem in which the time required to install the transport member and provide a logistics system may be increased.

In addition, when establishing a new factory equipped with a transportation means, changing the factory line, or changing only the location of a specific device, since the worker finds the electrical wiring of the above-mentioned devices and connects the electrical wiring to the newly designed location, there is a problem in which the wiring work may take a long time or the electrical wiring may be connected depending on a worker's level of skill.

According to some example embodiments, by wiring modularization of the transport member and simply connecting the transport member with other transport members or electrical wiring, work time may be shortened and system efficiency may be increased.

Hereinafter, example embodiments according to an embodiment will be described in detail with reference to the drawings.

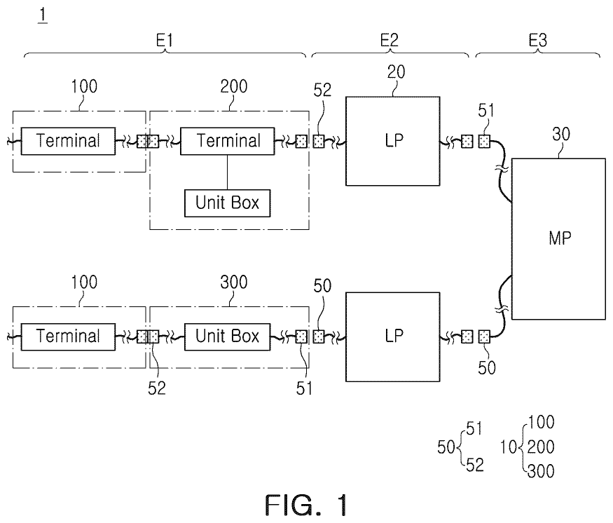

FIG. 1 is a schematic diagram of the electrical wiring of the battery transport system according to an embodiment.

Referring to FIG. 1, a wiring modularized battery transport system according to some embodiments may include a plurality of transport members 10 for transporting transport objects, a local panel (LP) 20 electrically connected to the transport member, and a wiring panel (MP) 30 electrically connected to the local panel 20, and the plurality of transport members 10, the local panel 20, and the wiring panel 30 may be detachably connected to each other through a connector 50.

In detail, a wiring modularized battery transport system 1 according to an embodiment may include a first wiring portion E1 including a plurality of transport members 10 for transporting the transport object T in a predetermined direction (or transport direction), a second wiring portion E2 including a local panel 20 electrically connected to at least one of the plurality of transport members 10, a third wiring portion E3 including a wiring panel 30 that is electrically connected to the local panel 20 and supplies power to the local panel 20, and a connector 50 that is provided on the first wiring portion E1, the second wiring portion E2, and the third wiring portion E3, respectively, and electrically connects the first wiring portion E1, the second wiring portion E2, and the third wiring portion E3 to each other. The connector 50 may detachably connect the first wiring portion E1, the second wiring portion E2, and the third wiring portion E3 to each other. For example, the first to third wiring portions E1, E2, and E3 may be electrically connected to each other in a detachable manner through the connector 50. Meanwhile, the wiring portion may mean an ‘electronic portion’ that includes electronic components and wiring components.

In this case, the ‘transported object T’ may mean a transported object that is transported in a predetermined direction (transport direction or first direction) by the transport member 10. In this case, the transport object is not particularly limited as long as it includes a battery cell including an electrode assembly. For example, the transport object T may be a tray in which one or more battery cells are loaded. On the other hand, the battery transport system 1 according to an embodiment is not limited to the type of transport object T.

In addition, ‘detachably coupled’ may mean that the configuration is coupled between the connectors 50 and electrically connected therebetween, or may be separated and coupled, to be electrically blocked.

In detail, according to some embodiments, the battery transport system 1 according to an embodiment may receive power through the wiring panel 30. The connector 50 according to an embodiment may include an input connector 51 that receives power based on the power supply of the wiring panel 30, and an output connector 52 that is connected to the input connectors 51 of other neighboring wiring components to supply power. In this case, ‘detachably coupled’ may mean that the output connector 52 of one member (for example, wiring panel; 30) is coupled to the input connector 51 of another member (for example, local panel; 20) and is electrically connected thereto, and is separated therefrom and electrically blocked.

On the other hand, in the present disclosure, the shape or structure of the connector 50 is not particularly limited. For example, there is no particular limitation as long as the input connector 51 and the output connector 52 are detachably coupled to each other. The input connector 51 and the output connector 52 may be combined in a manner such as snap-fit or the like.

In addition, according to some embodiments, the plurality of transport members 10 may be detachably connected to each other through the connector 50. In detail, at least one connector 50 according to an embodiment may be provided in each of the plurality of transport members 10. In this case, the plurality of transport members 10 are arranged in a predetermined direction (transport direction) in which the transport object T is transported, so that the transport object T may be transported in a predetermined direction. At this time, the plurality of transport members 10 may be electrically connected to each other in a detachable manner through the connector 50. In detail, each of the transport member 10 is also provided with an input connector 51 and an output connector 52, and may be detachably connected to the output connector 52 or the input connector 51 of the adjacent transport member 10.

On the other hand, the transport member 10 according to an embodiment is not particularly limited as long as it is a means that may transport the transport object in a predetermined direction. For example, the transport member 10 according to an embodiment may include a conveyor equipped with rollers. However, the present disclosure is not limited thereto, and is not particularly limited as long as it is a means that may transport the object to be transported to the desired location. The transport member 10 will be described later.

The local panel 20 may electrically connect the plurality of transport members 10 and the wiring panel 30 to each other. The local panel 20 may be connected to respective electrical wirings of the plurality of transport members 10 through the connector 50. In an embodiment not illustrated, the local panel 20 may be formed in the shape of a box inside which wiring components are connected to electrical wiring. The connectors 50 of a plurality of transport members 10 may be inserted into the interior of the local panel 20 and electrically connected.

According to some embodiments, respective local panels 20 may be electrically connected to a plurality of transport members 10, and each local panel 20 may be electrically connected to one wiring panel 30. For example, the local panel 20 may function as an electrical hub between the plurality of transport members 10 and the wiring panel 30. For example, the wiring panel 30 may supply power to a plurality of transport members 10 through the local panel 20.

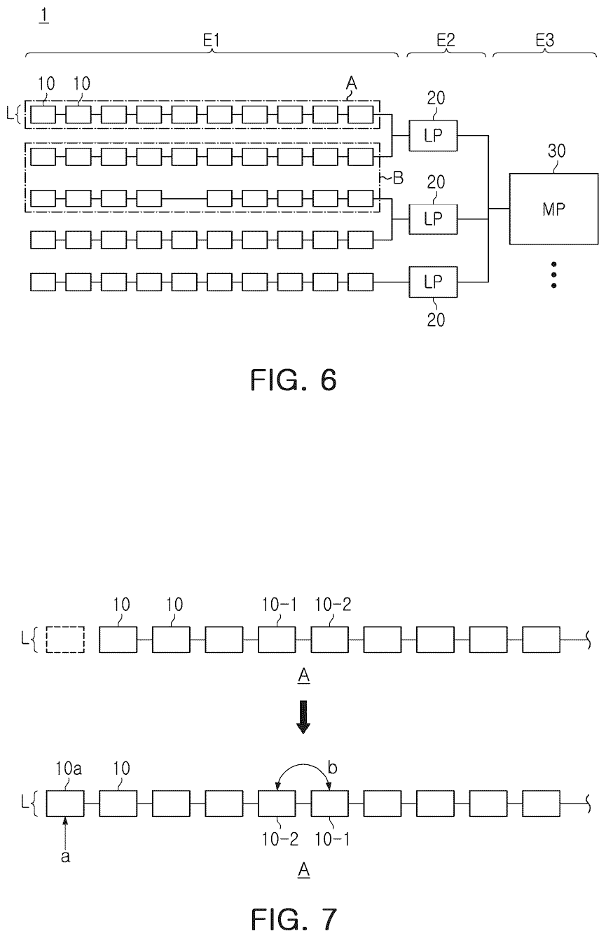

In addition, the plurality of transport members 10 in the first wiring portion E1 may form one or more transport lines L (see FIG. 6), and each local panel 20 may be electrically connected to at least one transport line L. In this case, which transport line L it is may be displayed on the input connector 52 at the end of each transport line L, such that it is easy to see which transport line L is connected to the local panel 20.

On the other hand, the transport member 10 may be directly connected to the wiring panel 20, but for the efficiency of the electrical wiring of each transport member 10, it may be preferable to be connected to the local panel 20.

The wiring panel 30 may be electrically connected to one or more local panels 20 through a connector 50. According to some embodiments, the wiring panel 30 may be provided with a connector 50 (in detail, an output connector 52) electrically connected to a connector 50 (in detail, an input connector 51) of the local panel 20. The wiring panel 30 may be formed in the shape of a box in which wiring components are accommodated. The wiring panel 30 may supply power to a plurality of transport members 10 through the local panel 20.

In this manner, the wiring panel 30 is connected to a plurality of local panels 20, and the plurality of local panels 20 are each electrically connected to a plurality of transport members, thereby increasing the efficiency of wiring work.

The input connectors 51 of a plurality of local panels 20 may be inserted into the wiring panel 30. To easily identify which local panel 20 it is, each input connector 51 of the local panel 20 may be distinguished from other local panels 20 by location, characteristics, number or the like thereof.

On the other hand, in the present disclosure, there is illustrated to be one wiring panel 30, but the present disclosure is not limited thereto, and for example, a plurality of wiring panels 30 may be provided.

The connector 50 may be provided at the end of the electrical wiring of respective wiring components (transport member, local panel, wiring panel, and the like) to electrically connect the wiring components to each other. The connector 50 according to an embodiment is not particularly limited as long as it may be easily mounted and detached. For example, the connector 50 according to an embodiment is not particularly limited as long as it is detachably coupled to a connector 50 of another member and electrically connected to each other.

Additionally, as described above, the connector 50 may include an input connector 51 disposed on a side that receives power from the wiring panel 30 and an output connector 52 that transmits power to the input connector 51 of other wiring components. Based on the connection path of the electrical wiring, the input connector 51 may be a connector disposed closer to the wiring panel 30, and the output connector 52 may be a connector 50 disposed farther than the input connector 51. On the other hand, the input connector 51 and the output connector 52 are used to describe the current path supplied from the wiring panel 30, and there is no particular limitation as long as the structure allows the input connector 51 and the output connector 52 to be coupled to each other and electrically connected. Additionally, in some embodiments, the input connector 51 of a specific means may not be connected to the input connector 51 of another means. Likewise, the output connector 52 of a specific means may not be connected to the output connector 52 of another means. For example, the input connector 51 and the output connector 52 are provided in a male and female structure, so that the worker may perform the work of binding the connectors so that the current path between respective means does not reverse.

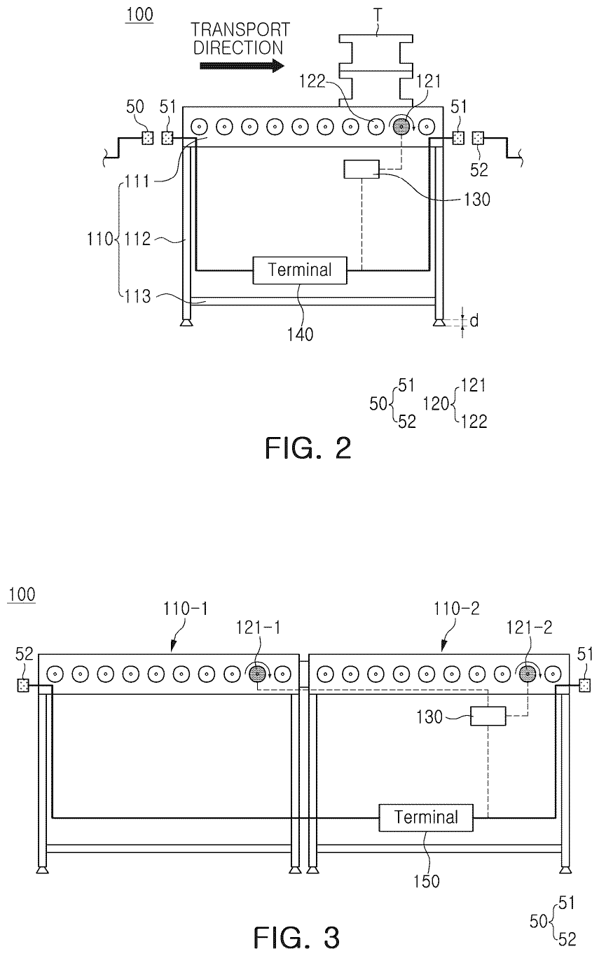

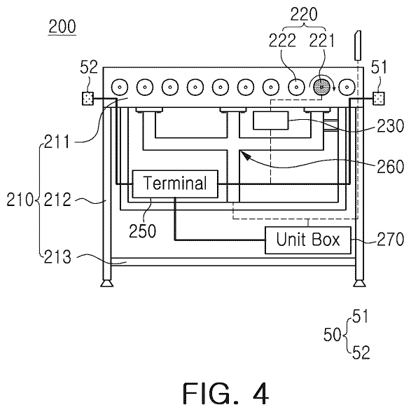

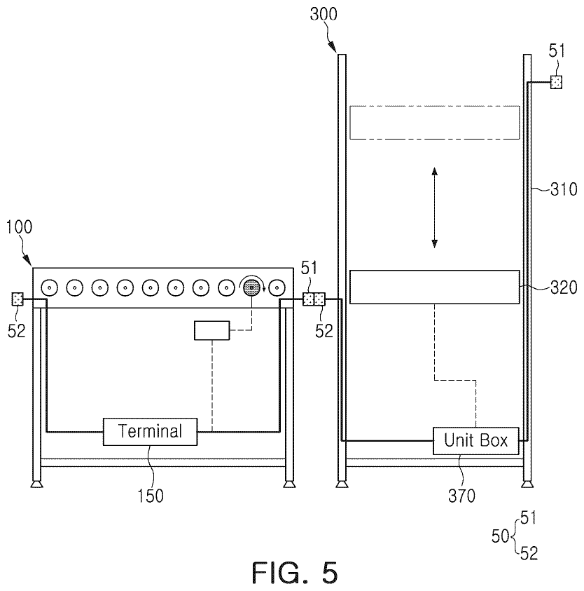

On the other hand, as described later, the transport member 10 according to an embodiment may include at least one of a first transport member (100, see FIG. 2), a second transport member (200, see FIG. 4), and a third transport member (300, see FIG. 5). Each transport member 10 may be wiring-modularized with electrical wiring work, such as terminals, completed therein. The wiring modularization structure is described later.

Hereinafter, the transport member 10 forming the first wiring portion E1 according to an embodiment will be described with reference to the drawings. On the other hand, in the description below, ordinal numbers such as ‘1st, 2nd, and 3rd’ in parentheses ( ) are only to distinguish the configurations of the first transport member 100, the second transport member 200, and the third transport member 300, and may have the same configuration.

FIG. 2 is a schematic diagram of the first transport member according to an embodiment.

Referring to FIG. 2, the transport member 10 according to an embodiment may include a first transport member 100 provided with a connector 50. The first transport member 100 may include a frame portion 110 (first frame portion), a roller unit 120 (first roller unit) disposed on the frame portion 110 and transporting the transport object T, a roller driving unit 130 (first roller driving unit) that supplies power to and controls the roller unit 120, and a terminal portion 150 (first terminal portion) that electrically connects the roller driving unit 130 and the connector 50.

Wiring components such as a roller driving unit 130 or a terminal portion 150 may be disposed on the frame portion 110. The frame portion may include a body frame 111 (first body frame) extending in the transport direction of the transport object T, and a support frame 112 (first support frame) supporting the body frame 111. The body frame 111 may extend from one side to the other side on the transport direction. Roller units 120 may be arranged in one direction on the body frame 111. The support frame 112 may extend from the body frame 111 toward the ground and support the body frame 111 against the ground. According to some embodiments, the support frame 112 may be provided so that the bottom height d is adjustable.

Additionally, according to an embodiment, the frame portion 110 may further include a reinforcement frame 113 provided on the support frame 112. The reinforcement frame 113 may support the support frame 112 to prevent the support frame 112 from being bent or damaged. In the drawing, the reinforcement frame 113 is illustrated as extending in the transport direction and structurally connecting two support frames 112 facing each other in the transport direction, but is not limited thereto, and may be provided to structurally connect two support frames 112 that extend in a direction perpendicular to the transport direction and face each other in a direction perpendicular to the transport direction.

The roller unit 120 may include a plurality of rollers. The roller unit 120 may be arranged in one direction in the body frame 111 to transport the transport object in the transport direction. The roller unit 120 may include a driving roller 121 (first driving roller) that is electrically connected to the roller driving unit 130 and rotates, and an idler roller 112 that rotates by the movement of the transport object. The driving roller 121 may be a roller that is rotatably disposed on the body frame 111 and rotated by the roller driving unit 130. The idler roller 122 may be rotatably disposed on the body frame 111 adjacent to the driving roller 121. The idler roller 122 may be provided to rotate by friction with the transport object T moving on the body frame 111.

The roller driving unit 130 may be connected to the driving roller 121 of the roller unit 120 and supply power to the driving roller 121. The roller driving unit 130 controls the rotation of the driving roller 121 and supplies power, and may be a power moller. In addition, the roller driving unit 130 is connected to a separate control unit and may control the transport speed of the transport object T while adjusting the rotation RPM of the driving roller 121.

The terminal portion 150 is electrically connected to the connector 50 and may supply power to a wiring component (for example, a roller driving unit 130) inside the transport member 100. The terminal portion 150 is a component electrically connected to the connector 50 and the roller driving unit 130, and the shape or structure thereof is not particularly limited.

The connector 50 may be electrically connected to the first transport member 100 and connectors of other external wiring components. For example, the connector 50 of the first transport member 100 may be electrically connected to the connector 50 of the other transport member 10 or the connector 50 of the local panel 20. According to some embodiments, the connector 50 may be disposed on both sides in the transport direction, and may thus be electrically connected to the connector 50 of the other transport member 10 disposed on both sides of the first transport member 100.

On the other hand, in the first transport member 100 according to an embodiment, wiring equipment such as electrical wiring or the like may be modularized. In this case, ‘Wiring Modularization’ according to an embodiment may mean that wiring components (for example, terminal; or roller driving unit, unit box, and the like) for transporting the transport object T are installed inside the transport member 10, and in detail, may mean that the electrical wiring work of the wiring components is installed on the frame portion 110 of the first transport member 100 in a state in which electrical wiring work has been completed. Therefore, in some embodiments of the present disclosure, the battery transport system may be easily installed by connecting respective transport members 10 with a connector while only the transport member 10 are arranged, and separate wiring work is not required.

In detail, in the first transport member 100 according to an embodiment, the roller driving unit 130 and the terminal portion 150 may be disposed inside the frame portion 110. In this case, ‘the inside of the frame portion 110’ may mean an internal space formed by the body frame 111, the support frame 112, and the ground. For example, the roller driving unit 130 and the terminal portion 150 may be mounted in the frame portion 110.

Thereby, since the first transport member 100 has built-in electrical wiring or wiring components, no separate wiring work is required other than connecting the connector 50 afterwards. In this manner, wiring modularization may mean completing the wiring work between the remaining wiring components except for the connection of the connector 50 and embedding the same in the transport member 10.

FIG. 3 is a schematic diagram of a transport member according to an embodiment.

Referring to FIG. 3, a schematic diagram of the first transport member 100 according to an is embodiment illustrated. Referring to FIG. 3, the first transport member 100 has driving rollers 121-1 and 121-2 respectively disposed on a plurality of frames 110-1 and 110-2, and may be electrically connected to one terminal portion 150 and one roller driving unit 130, respectively.

In detail, the frame portion 110 of the first transport member 100 may be arranged in plural (100-1 and 100-2) in the transport direction, and the plurality of frame portions 110-1 and 110-2 may be coupled to each other by connection parts. Additionally, the driving rollers 121-1 and 121-2 may be respectively disposed on the body frames 111 of respective frame portions 110-1 and 110-2. In this case, the roller driving unit 130 may be disposed on any one of the plurality of frame portions 110-1 and 110-2 and electrically connected to respective driving rollers 121-1 and 121-2.

For example, according to some embodiments, the first transport member 100 may include a plurality of frame portions 110, and wiring components arranged in the plurality of frame portions 110 may share one roller driving unit 130.

In detail, the first roller driving unit 120 disposed on any one of the plurality of first frame portions 110-1 and 110-2 may be electrically connected to the first driving rollers 121-1 and 121-2 disposed in each of the plurality of first frame portions 110.

Additionally, according to an embodiment, the first transport member 100 may include an input connector 51 disposed on one side to receive current, and an output connector 52 to transmit current to another transport member. In this case, the terminal portion 150 may electrically connect the input connector 51, the output connector 52, and the roller driving unit 130. In this case, the terminal portion 150 may be placed in any one of the plurality of frame portions 110. In detail, the wiring components of the plurality of frame portions 110 may share one terminal portion 150.

In detail, the terminal portion 150 disposed on any one of the plurality of first frame portions 110-1 and 110-2 may electrically connect each roller driving unit 130 and the input and output connectors 51 and 52.

FIG. 4 is a schematic diagram of a second transport member equipped with an accessory member according to an embodiment.

Referring to FIG. 4, the plurality of transport members 10 according to an embodiment may include a second transport member 200 provided with a connector 50. The second transport member 200 may have a structure further including an accessory member 260 and a unit box 270 that supplies power to the accessory member 260 in the above-described first transport member 100. Hereinafter, the second transport member 200 will be described, but any content that overlaps with the first transport member 100 will be omitted.

The second transport member 200 may include a frame portion 210 (second frame portion), a roller unit 220 (second roller unit), a roller driving unit 230 (second roller driving unit) and a terminal portion 250 (second terminal portion) that electrically connects the roller driving unit 230 and the connector 50. Additionally, according to some embodiments, the second transport member 200 may further include the accessory member 260 to assist in transporting the transport object T, and a unit box 270 that electrically connects the accessory member 260 and the terminal portion 250 to supply power to the accessory member 260.

In this case, the second transport member 200 may be wiring-modularized. In detail, the roller driving unit 230 and the terminal portion 250 of the second transport member 200 may have electrical wiring completed with respective wiring components (driving roller; 211, connector; 50), and the like, and may be placed inside the frame portion 210. The inside of the frame portion 210 may mean being mounted in a space formed by the body frame 211, the support frame 212, and the ground, or being mounted in the frame portion 210.

The frame portion 210 may include a body frame 211 (second body frame) and a support frame 212 that supports the body frame 211 with respect to the ground. In addition, the frame portion 210 may further include a reinforcement frame 213 provided on the support frame 212 to reinforce the support frame 212.

The roller unit 220 may include a driving roller 221 (second driving roller) and an idler roller 222 that rotate when supplied with power.

At least one accessory member 260 may be provided and mounted on the frame portion 210. The accessory member 260 is not particularly limited as long as it may assist in transporting the transport object T transported through the roller unit 220. On the other hand, although the expression “accessory” is used for the accessory member in this disclosure, t should be understood that it is not a configuration that is incidentally subordinate to the transport member.

Additionally, the accessory member 260 according to an embodiment may include a diverter, which transports the transport object in a direction different from the transport direction, a home stand that may lift the transport object T from the roller unit 220, a turn table that rotates the transport object, and the like. However, the accessory member 260 according to an embodiment is not limited thereto, and is not particularly limited as long as it transports the transport object T in a manner other than the roller unit 220 provided as a rotating roller. The above-described accessory member may be supplied with power through the unit box 270.

The unit box 270 may be electrically connected to the terminal portion 250 of the second transport member 200. For example, the unit box 270 may electrically connect one or more accessory members 260 and the terminal portion 250 to each other (illustrated as a dotted line in the drawing). The unit box 270 may be in the form of a box that accommodates wiring components that are electrically connected to cables, such as electrical wiring. The cable coming out of the terminal portion 250 may be electrically connected to the accessory member 260 inside the unit box 270.

As described above, according to an embodiment, the unit box 270 may be installed inside the frame portion 210. In detail, the unit box 270 may be mounted in any one of the body frame 211, the support frame 212, or the reinforcement frame 213, or may be placed in a space formed by the body frame 211, the support frame 212, and the ground.

According to some embodiments, the unit box 270 may be spaced at mm or more from the ground. Additionally, according to some embodiments, the unit box 270 may be mounted in the frame portion 210 through reinforcing means such as a separate bracket. The unit box 270 may be perforated so that various electrical cables may be inserted, or a separate cable may protrude from the box.

In this manner, the second transport member 200 may be modularized as the roller driving unit 230, the terminal portion 250 and the unit box 270 are installed inside the frame portion 210, with the electrical wiring of the wiring components connected.

FIG. 5 is a schematic diagram of the third transport member according to an embodiment.

According to some embodiments, the plurality of transport members 10 may include a third transport member 300 provided with a connector 50. The third transport member 300 is a means for transporting the transport object T and may be provided with a transport member other than a roller. For example, the third transport member 300 may be provided with only the accessory member 260 and the unit box 270, as compared with the configurations of the second transport member 200.

Hereinafter, the third transport member 300 will be described, but overlapping content in the above-described first transport member 100 and second transport member 200 will be omitted.

The third transport member 300 according to an embodiment may include a lifter lifting and lowering the transport object in the height direction, and the like. The third transport member 300 may include a unit box 370. The unit box 370 of the third transport member 300 may be electrically connected to the connector 50. In detail, the third transport member 300 according to an embodiment may include a frame portion 310 (third frame portion) equipped with an auxiliary member 320 capable of transporting the transport object T in a direction different from the transport direction of the transport object T, and the unit box 370 that electrically connects the auxiliary member 320 and the connector 50 to each other. In this case, the unit box 370 may be placed inside the frame portion 310, with electrical wiring connected.

On the other hand, the connector 50 of the third transport member 300 may be connected to the connector 50 of the neighboring transport member 10 (the first transport member 100 in the drawing) and electrically connected to the terminal portion 150 of the neighboring transport member 10. The unit box 370 of the third transport member 300 may be electrically connected to the terminal portion 150 of the neighboring transport member 10 to receive power.

In detail, the third transport member 300 may be disposed adjacently to at least one of the first transport member 100 or the second transport member 200 in the transport direction. In this case, the unit box 370 of the third transport member 300 may be electrically connected to at least one of the terminal portion 150 (first terminal portion) of the neighboring first transport member 100 or the terminal portion 250 (second terminal portion) of the second transport member 200.

For example, the third transport member 300 may not be provided with a separate roller driving unit and terminal portion in the frame portion 310, but may be provided with only the unit box 370 as a wiring component.

As described above in FIGS. 3 to 5, the transport member 10 according to an embodiment has the ends of respective components constituting the battery transport system 1 finished with connectors, and may thus be quickly and accurately coupled to adjacent wiring components.

Hereinafter, the modularized structure of the entire system using connectors will be described with reference to the drawings.

FIG. 6 is a diagram illustrating an electrical wiring system according to an embodiment.

According to an embodiment, the first wiring portion E1 may have a plurality of transport members 10 forming a transport line L. The plurality of transport members 10 may include at least one of the above-described first transport member 100, second transport member 200, or third transport member 300. In the first wiring portion E1, the transport line L may be provided in a plurality of rows.

Each of the plurality of transport lines L may be electrically connected to one local panel 20 of the second wiring portion E2. In detail, the connector 50 of any one of the plurality of transport members 10 forming the transport line L and the local panel 20 may be electrically connected. Additionally, the local panel 20 may be connected to at least one transport line L and electrically connected to one wiring panel 30.

On the other hand, in the present disclosure, at least one of the plurality of transport members 10 forming the transport line L may be provided such that a position there is changeable based on the transport direction of the transport object T through the connector 50. The following will be described with reference to the drawings.

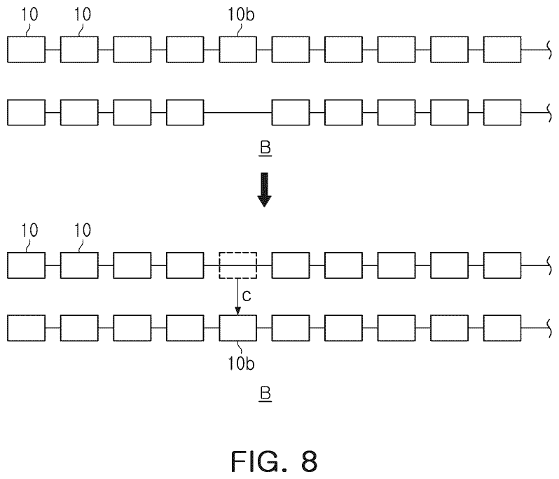

FIG. 7 is a view of A in FIG. 6, and FIG. 8 is a view of B in FIG. 6.

Referring to FIG. 7, one transport line L may include a plurality of transport members 10. In this case, a separate transport member 10 may be added to the transport line L through the connector 50 (see a). In the drawing, the additional transport member 10a is illustrated as being connected to the end of the transport line L, but is not limited thereto and may be connected between a plurality of transport members 10 through a connector. In detail, since the transport member 10 is wiring-modularized, the worker may simply add the transport member 10 to the transport line L through the connector 50.

The present disclosure is not limited thereto, and the electrical of the plurality of transport members 10 forming one transport line L may be changed. In detail, the positions of the neighboring transport members 10-1 and 10-2 among the plurality of transport members 10 forming the transport line L may be adjusted (see b). Since the transport member 10 is wiring-modularized and finished with a connector, the worker does not need separate wiring work and may change the position between the transport members 10 by simply connecting the connector thereto.

Referring to FIG. 8, the transport member 10 may be electrically connected to another transport line L. In detail, the electrical position of the transport member 10b of the transport line L connected to one local panel 20 may be changed to the position of the transport line L connected to another local panel 20 (see c).

If the plurality of transport members 10 are not wiring-modularized, separate wiring work is required, such as installing the roller driving units 130 and 230, the terminal portions 150 and 250, and the like, inside the transport member 10. According to some embodiments of the present disclosure, since the wiring components are built into the transport member 10 itself and are modularized, the worker does not need to perform separate wiring work.

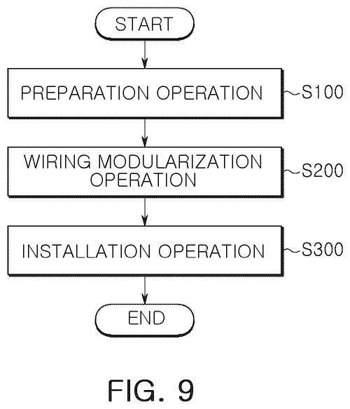

FIG. 9 is a flowchart illustrating a method of constructing a battery transport system according to an embodiment.

A method of constructing a battery transport system according to an embodiment may include a preparation operation (S100), a wiring modularization operation (S200), and an installation operation (S400).

In detail, the method of constructing a battery transport system according to an embodiment may include a preparation operation (S100) of preparing a first wiring portion E1 including a plurality of transport members 10 for transporting the transport object T in a predetermined direction, a second wiring portion E2 including one or more local panels 20, and a third wiring portion E3 including one or more wiring panels 30, a wiring modularization operation (S200) of providing a connector 50 on each of the plurality of transport members 10 of the first wiring portion E1, the second wiring portion E2, and the third wiring portion E3, and an installation operation (S300) of electrically connecting the first wiring portion E1, the second wiring portion E2, and the third wiring portion E3 to each other through the connector 50.

The preparation operation (S100) is an operation before wiring modularization of the transport member 10 and may be an operation of preparing the first wiring portion E1, the second wiring portion E2, and the third wiring portion E3. Additionally, the preparation operation (S100) may include preparing at least one of the first transport member 100, the second transport member 200, and the third transport member 300.

The wiring modularization operation (S200) is an operation before the installation operation (S300), in which the ends of the cables of respective wiring portions E1, E2, and E3 may be closed with connectors 50. For example, the wiring modularization operation (S200) may include mounting connectors on the ends of the wires of the plurality of transport members 10, the local panel 20, and the wiring panel 30.

In the present disclosure, ‘wiring modularization’ means that various wiring components, such as electrical wiring and the like, may be installed on the frame portions 110, 210, and 310 inside each of the plurality of transport members 10. For example, various wiring components may be built into the transport member 10 and the ends of the wires may be closed with connectors 50. In addition, it may mean that a connector 50 is provided at the ends of respective wires of the first wiring portion E1, the second wiring portion E2, and the third wiring portion E3. For example, to build the battery transport system 1 by connecting only the connector 50 in the installation operation (S300), configurations in all previous wiring work may be built into the inside of the transport member 10.

Additionally, the wiring modularization operation (S200) may include the operation of modularizing respective wiring components of the transport member 10 according to an embodiment. In detail, in the wiring modularization operation (S200), the roller driving units 130 and 230 and the connector 50 may be electrically connected to each other through the terminal portions 150 and 250 of the transport member 10, and the roller driving units 130 and 230 and the terminal portions 150 and 250 may be placed inside the frame portions 110 and 210.

In detail, the wiring modularization operation (S200) according to an embodiment may include mounting the roller driving unit 130, which is electrically connected to the driving roller 121 in the first transport member 100, inside the frame portion 110. Additionally, according to some embodiments, the wiring modularization operation (S200) may include electrically connecting the roller driving unit 130 and the connector 50 to the terminal portion 150 and mounting the terminal portion 150 inside the frame portion 110.

In addition, in the embodiment, the wiring modularization operation (S200) may include mounting the roller driving unit 230, which is electrically connected to the driving roller 221 in the second transport member 200, inside the frame portion 210. Additionally, according to some embodiments, the wiring modularization operation (S200) may include electrically connecting the roller driving unit 230 and the connector 50 to the terminal portion 250 and mounting the terminal portion 250 inside the frame portion 210. Additionally, according to some embodiments, the wiring modularization operation (S200) may include mounting the accessory member 260 to the frame portion 210, and electrically connecting the unit box 270 that supplies power to the accessory member 260 and the terminal portion 250 and disposing the same inside the frame portion 210.

In addition, in the embodiment, the wiring modularization operation (S200) may include installing the unit box 370 in the frame portion 310 of the third transport member 300 and electrically connecting the unit box 370 and the connector 50.

In the installation operation (S300), the plurality of transport members 10 may be electrically connected to each other to form the first wiring portion E1 provided with the transport line L. For example, the plurality of transport members 10 may be electrically connected to each other using the connector 50 to form a transport line L.

Additionally, the installation operation (S300) may include coupling the connectors of the first wiring portion E1, the second wiring portion E2, and the third wiring portion E3 to each other. In detail, in the installation operation (S300), the connector 50 of at least one of the plurality of transport members 10 and the connector 50 of the local panel 20 may be connected to each other, and the connector 50 of the local panel 20 and the connector 50 of the wiring panel 30 may be connected to each other. For example, the installation operation (S300) may include connecting the first wiring portion E1 and the second wiring portion E2 through the connector 50, and electrically connecting the second wiring portion E2 and the third wiring portion E3.

For example, before the installation operation (S300), respective transport members 10 and respective panels 20 and 30 are wiring-modularized and finished with connectors, and thus, in the installation operation (S300), respective connectors may be simply connected to each other electrically.

On the other hand, in the present disclosure, a transport operation (not illustrated) may be further included between the wiring modularization operation (S200) and the installation operation (S300). The transport operation may be an operation of transporting the modularized first wiring portion E1, second wiring portion E2, and third wiring portion E3 to a predetermined location. For example, the wiring modularization operation (S200) may be completed in area A, and then respective wiring portions E1, E2 and E3 are transported to the separated area B, and the installation operation (S300) may be completed in area B. In this case, the worker in area B may simply build the battery transport system 1 quickly and accurately by i) connecting the plurality of transport members 10 to each other with connectors to form a first wiring portion E1 provided with a transport line L, and ii) connecting the first wiring portion E1, the second wiring portion E2, and the third wiring portion E3 with a connector.

As set forth above, with a battery transport system and a method of constructing the same according to some embodiments, the time required for wiring work on a transport member may be significantly reduced.

In a battery transport system and a method of constructing the same according to some embodiments, a wiring structure of the transport member may be quickly changed.

In a battery transport system and a method of constructing the same according to some embodiments may improve the reliability and safety of wiring work of the transport member.

Only specific examples of implementations of certain embodiments are described. Variations, improvements and enhancements of the disclosed embodiments and other embodiments may be made based on the disclosure of the present patent document.

The content described above is merely an example of applying the principles of the present disclosure, and other configurations may be further included without departing from the scope of the present disclosure.

What is claimed is:

1. A battery transport system comprising:
a first wiring portion including a plurality of transport members transport a transported object in a predetermined direction;
a second wiring portion including a local panel electrically connected to at least one of the plurality of transport members;
a third wiring portion including a wiring panel electrically connected to the local panel and supplying power to the local panel; and
a connector respectively provided in the first wiring portion, the second wiring portion, and the third wiring portion, and electrically connecting the first wiring portion, the second wiring portion, and the third wiring portion to each other,
wherein the connector connects the first wiring portion, the second wiring portion, and the third wiring portion to each other in a detachable manner.

2. The battery transport system of claim 1, wherein the connector is provided on each of the plurality of transport members, and
the plurality of transport members are arranged in the predetermined direction and electrically connected to each other through the connector in a detachable manner.

3. The battery transport system of claim 1, wherein the plurality of transport members includes a first transport member provided with the connector,
wherein the first transport member includes,
a first frame portion including a first body frame and a first support frame supporting the first body frame;
a first roller unit arranged in the predetermined direction on the first body frame and including a first driving roller rotating when supplied with power;
a first roller driving unit supplying power to and controlling the first roller unit; and
a first terminal portion electrically connecting the first roller driving unit and the connector to each other, and
the first roller driving unit and the first terminal portion are disposed inside the first frame portion provided by the first body frame and the first support frame.

4. The battery transport system of claim 3, wherein the first frame portion of the first transport member is provided as a plurality of first frame portions arranged in the predetermined direction and coupled to each other by a connection portion,
the first driving roller is respectively disposed on the first body frames of the plurality of first frame portions, and
the first roller driving unit disposed on any one of the plurality of first frame portions is electrically connected to each of the first driving rollers disposed on the plurality of first frame portions.

5. The battery transport system of claim 4, wherein the connector of the first transport member includes an input connector disposed on one side of the plurality of first frame portions and receiving current, and an output connector disposed on the other side and supplying current to a neighboring transport member, and
the first roller driving unit disposed on any one of the plurality of first frame portions electrically connects the first roller driving unit, the input connector, and the output connector to each other.

6. The battery transport system of claim 1, wherein the plurality of transport members include a second transport member provided with the connector,
wherein the second transport member includes,
a second frame portion including a second body frame and a second support frame supporting the second body frame;
a second roller unit arranged in the predetermined direction in the second body frame and including a second driving roller rotating when supplied with power;
a second roller driving unit supplying power to and controlling the second driving roller;
a second terminal portion electrically connecting the second roller driving unit and the connector to each other;
an accessory member configured to assist in transporting the transport object; and
a unit box supplying power to the accessory member, and
the second roller driving unit, the second terminal portion, and the unit box are disposed inside the second frame portion provided by the second body frame and the second support frame.

7. The battery transport system of claim 1, wherein the plurality of transport members includes a third transport member provided with the connector,
wherein the third transport member includes,
a third frame portion disposed with an auxiliary member capable of transporting the transport object in a direction different from the predetermined direction; and
a unit box electrically connecting the auxiliary member and the connector to each other, and
the unit box is disposed inside the third frame portion.

8. The battery transport system of claim 7, wherein the plurality of transport members further includes a first transport member and a second transport member provided with the connector, and
the unit box of the third transport member is electrically connected to either a first terminal portion of the first transport member or a second terminal portion of the second transport member, neighboring to each other.

9. The battery transport system of claim 2, wherein at least one of the plurality of transport members is configured to be changeable in a position, based on the predetermined direction, through the connector.

10. A method of constructing a battery transport system, comprising:
a preparation operation of preparing a first wiring portion a plurality including of transport members transporting a transport object in a predetermined direction, a second wiring portion including at least one local panel, and a third wiring portion including at least one wiring panel;
a wiring modularization operation of providing a connector on the plurality of transport members of the first wiring portion, the second wiring portion, and the third wiring portion; and
an installation operation of electrically connecting the first wiring portion, the second wiring portion, and the third wiring portion to each other by the connector.

11. The method of claim 10, wherein at least one of the plurality of transport members includes a frame portion including a body frame, a roller unit arranged on the body frame and transporting the transport object, a roller driving unit supplying power to and controlling the roller unit, and a terminal portion electrically connecting the roller driving unit and the connector to each other, and
the wiring modularization operation includes electrically connecting the roller driving unit and the connector to each other through the terminal portion, and disposing the roller driving unit and the terminal portion inside the frame portion.

12. The method of claim 11, wherein in the wiring modularization operation, the connector is mounted on ends of wires of the plurality of transport members, the local panel, and the wiring panel.

13. The method of claim 10, wherein the installation operation includes arranging the plurality of transport members in a transport direction of the transport object, and connecting respective connectors provided on the plurality of transport members to each other in the predetermined direction.

14. The method of claim 13, wherein the installation operation includes connecting the connector of at least one of the plurality of transport members and the connector of the local panel to each other, and connecting the connector of the local panel and the connector of the wiring panel to each other.

15. The method of claim 10, further comprising transporting the first wiring portion, the second wiring portion, and the third wiring portion to a predetermined position, between the wiring modularization operation and the installation operation.
